(19) United States
(12) Patent Application Publication
(10) Pub. No.: US 2010/0009666 A1
(43) Pub. Date: Jan. 14, 2010

(54) METHOD AND SYSTEM FOR PROVIDING MOBILE TELEPHONE CALL TERMINATION SERVICE OVER OPEN SEA

(75) Inventors: Young-beom Kim, Daejeon (KR); Young-kyu Lee, Daejeon (KR)

Correspondence Address: Muncy, Geissler, Olds & Lowe, PLLC, P.O. BOX 1364, FAIRFAX, VA, 22038-1364, US

(73) Assignee: Korea Research Institute of Standards and Science, Daejeon (KR)

(21) Appl. No.: 12/438,837

(22) PCT Filed: Jul. 20, 2007
(86) PCT No.: PCT/KR07/03509

§ 371 Date: Feb. 25, 2009

(30) Foreign Application Priority Data
Aug. 30, 2006 (KR) 10-2006-0083111

(51) Int. Cl. H04M 3/42

(52) U.S. Cl. 455/417

(57) ABSTRACT

Disclosed herein are method and system for providing mobile telephone call termination service over open sea. The system includes a ticketing system which applies to a mobile communication service provider of a customer's mobile telephone for a call termination service; a call termination service provision system which transmits a call termination signal when a call connection to the mobile telephone number is requested, according to the call termination service application, and establishes a call connection; and an internal switching system which is mounted in the airplane or the ship, receives the call termination signal from the call termination service provision server, searches for the customer corresponding to the telephone number, notifies the customer that the call termination signal is received, and transmits/receives voice data to/from the call termination service provision system according to a call connection request of the customer.

### BACKGROUND OF THE INVENTION

1. Field of the Invention

The present invention relates to a mobile telephone call termination service technology, and more particularly to a mobile telephone call termination service capable of allowing a call received by a mobile telephone of a user, who applies for a mobile telephone call termination service when purchasing an airplane or ship ticket, to be received through a representative telephone of the airplane or ship over open sea.

2. Description of the Related Art

As a mobile communication technology and a terminal technology have been developed, most people have acquired mobile terminals. People who have mobile terminals can use a telephone service in a service region anytime and anywhere.

Conventionally, in order to allow a user to use his/her mobile terminal in a non-service region, that is, outside the country, a roaming service is used. The roaming service is used to perform communication in service regions of two communication service provides by affiliation between the two communication service providers.

For example, if a domestic communication service provider is affiliated with any communication service provider of United States of America or Japan so as to provide a roaming service, a customer who is subscribed to the domestic communication service provider can use his/her mobile terminal in a service region of the affiliated communication service provider when the customer travels in United States of America or Japan. However, since the roaming service mainly uses satellite communication, the cost of the call is high. Accordingly, the roaming service is unlikely to be used. While a user goes abroad by an airplane or a ship, and more particularly, over open sea, the user cannot receive a call using the roaming service. This is because the open sea does not belong to both the roaming service region and the service region of the mobile terminal which is currently being used.

In an airplane, a representative telephone in the airplane, for example, a telephone using satellite communication, is used in order to prevent main components of the airplane from being influenced by a radio frequency signal transmitted/received through a mobile terminal. The representative telephone mounted in the airplane is being used for only a call origination. Accordingly, when the airplane is flying or the ship is sailing over open sea, it is impossible to provide a mobile telephone call termination service to a customer.

### SUMMARY OF THE INVENTION

Therefore, the present invention has been made in view of the above problems, and it is an object of the present invention to provide a call termination service for allowing a customer to receive a call received by his/her mobile telephone over open sea using a communication network established in an airplane or a ship.

It is another object of the present invention to provide a call termination service for allowing a customer to receive a call, which is received by his/her mobile telephone, through a dedicated telephone mounted in a customer's seat.

In a system for providing a mobile telephone call termination service over open sea according to an aspect of the present invention, a passenger who uses an airplane or a ship makes a request for a call termination service including his/her mobile telephone number and desired service provision time information. A ticketing system operated by an airline company or a shipping company requests a call termination service provision system operated by a mobile communication service provider to register the mobile telephone number, the time information and a representative telephone number of the airplane or the ship according to the request for the call termination service, such that the representative telephone of the airplane or the ship registered previously receives a call when the call is received by the customer's mobile telephone.

The call termination service providing system switches the mobile telephone to a call termination service state when a current time reaches a time requested by the customer who applies for the mobile telephone call termination service, that is, the operation time of the airplane or the ship.

The call termination service providing system establishes a connection to the representative telephone of the airplane or the ship stored previously when a call connection to the mobile telephone which is in the call termination service state is requested, and transmits a call termination signal including the customer's mobile telephone number.

An internal switching system mounted in the airplane or the ship displays the name and the telephone number of the customer on a display device mounted in the airplane or the ship using the mobile telephone number included in the received call termination signal and notifies the customer that the call is received. The customer can have a telephone conversation using the representative telephone mounted at a predetermined position of the airplane or the ship according to the notification of the call termination.

Accordingly, the method and system for providing the mobile telephone call termination service system over open sea according to the present invention has an advantage that a call termination service can be provided to a customer.

In a system for providing a mobile telephone number call termination service over open sea according to another aspect of the present invention, a call termination service can be received through a telephone handset provided by the airplane or the ship.

In the airplane, seats are assigned to customers and call termination handsets are respectively mounted in the seats. In the internal switching system of the airplane, when a call termination signal is received from the call termination service provision system, a call connection to the call termination handset mounted in the seat of a corresponding customer is established by referring to the received mobile telephone number of the customer such that the customer can have a telephone conversation using the call termination handset.

In a system for providing a mobile telephone number call termination service over open sea according to another aspect of the present invention, a pager is provided to the customer to notify the customer that a call is received. Unlike the airplane, since the size of the ship is large, when a call termination signal including the customer's mobile telephone number is received by the representative telephone of the ship, the internal switching system accesses customer information using the telephone number and transmits a message that the call is received and the position of the representative telephone of the ship to the pager provided to the customer. Accordingly, the customer confirms that the call is received through the pager, goes to a place where the representative telephone is mounted, and has a telephone conversation.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view showing a system for providing a mobile terminal call termination service over open sea according to a preferred embodiment of the present invention;

FIG. 2 is a schematic block diagram showing a ticketing system according to a preferred embodiment of the present invention;

FIG. 3 is a schematic block diagram showing a call termination service providing system according to a preferred embodiment of the present invention;

FIG. 4 is a schematic block diagram showing an internal switching system according to a preferred embodiment of the present invention;

FIG. 5 is a schematic block diagram showing an internal switching system according to another embodiment of the present invention;

FIG. 6 is a schematic block diagram showing an internal switching system according to another embodiment of the present invention;

FIG. 7 is a schematic block diagram showing an internal switching system according to another embodiment of the present invention;

FIG. 8 is a flowchart illustrating a method for providing a mobile telephone call termination service over open sea using the call termination service provision system according to the preferred embodiment of the present invention;

FIG. 9 is a flowchart illustrating a method for providing a mobile telephone call termination service over open sea using the internal switching system according to the preferred embodiment of the present invention;

FIG. 10 is a flowchart illustrating a method for providing a mobile telephone call termination service over open sea using the internal switching system according to another embodiment of the present invention;

FIG. 11 is a flowchart illustrating a method for providing a mobile telephone call termination service over open sea using the internal switching system according to another embodiment of the present invention; and

FIG. 12 is a flowchart illustrating a method for providing a mobile telephone call termination service over open sea using the internal switching system according to another embodiment of the present invention.

### DETAILED DESCRIPTION OF THE PREFERRED EMBODIMENTS

Hereinafter, preferred embodiments of the present invention will be described in detail with reference to the accompanying drawings.

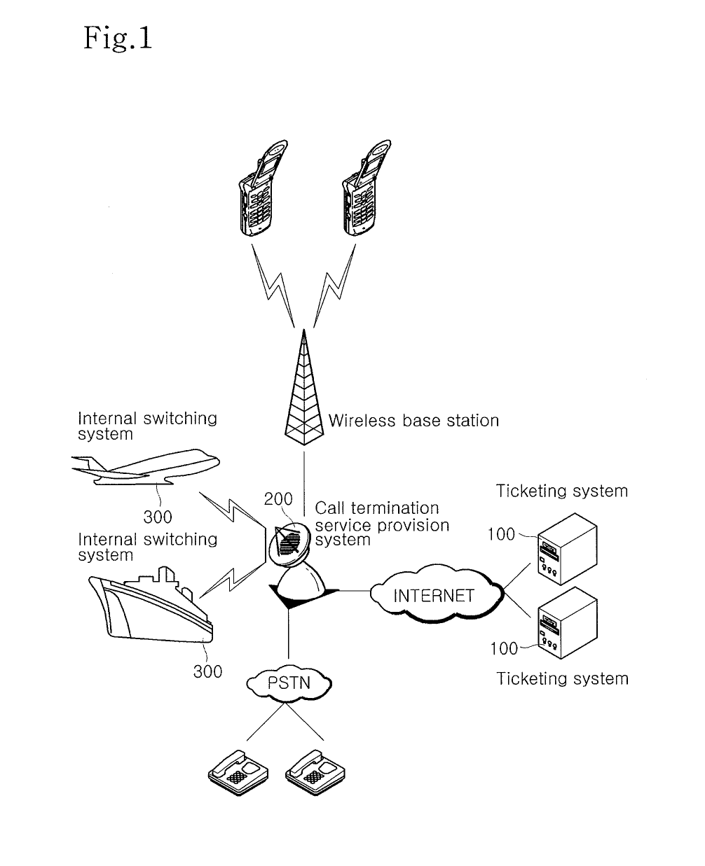

FIG. 1 is a schematic view showing a system for providing a mobile terminal call termination service over open sea according to a preferred embodiment of the present invention. As shown, the system for providing the mobile telephone call termination service over open sea according to the present invention includes a ticketing system 100 which issues a ticket of an airplane or a ship according to a customer's request and applies to a communication service provider of a customer's mobile terminal for a call termination service including a representative telephone number of the airplane or the ship, a customer's mobile telephone number and a service provision time according to a customer's request for the mobile telephone call termination service including the mobile telephone number and the service provision time; a call termination service provision system 200 which stores the customer's mobile telephone number and the representative telephone number of the airplane or the ship in correspondence with each other according to the call termination service application received from the ticketing system 100, transmits a call termination signal including a corresponding mobile telephone number to the representative telephone of the airplane or the ship corresponding to the telephone number when a call connection to the mobile telephone number is requested, and establishes the call connection according to a connection command of the customer, and an internal switching system 300 which is mounted in the airplane or the ship, receives the call termination signal from a call termination service provision server, searches for the customer corresponding to the telephone number, notifies the customer that the call termination signal is received, and transmits/receives voice data to/from the call termination service provision system 200 according to a call connection request of the customer. It is apparent to those skilled in the art that a wireless communication network and a satellite communication device for connecting the respective systems are included.

The ticketing system 100 is a system for reserving and issuing a ticket, which is operated by an airline company or a shipping company. The ticketing system 100 is used to receive a ticket reservation request online or offline and to reserve a ticket of an airplane or a ship. Since the ticketing system 200 is operated by the airline company or the shipping company in advance, the detailed description thereof will be omitted and only contents included in the present invention will be described in the present specification.

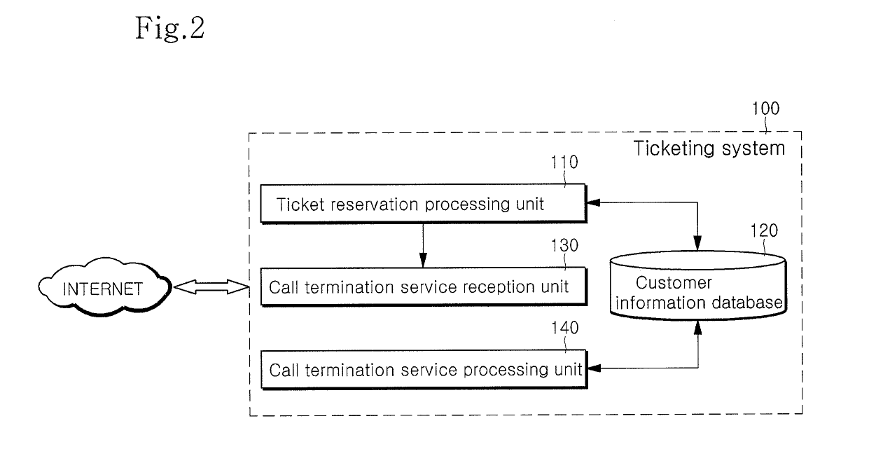

The ticketing system 100 receives a call termination service application including the customer's mobile telephone number and the service provision time from the customer at the time of ticket reservation, applies for the call termination service to the call termination service provision system 200 operated by the mobile communication service provider of the mobile telephone, receives a registration completion signal of the call termination service from the call termination service provision system 200, and notifies the customer that the registration completion signal is received. The description of the ticketing system 100 will be described in detail with reference to FIG. 2.

FIG. 2 is a schematic block diagram showing a ticketing system according to a preferred embodiment of the present invention. As shown, the ticketing system 100 according to the present invention includes a ticket reservation processing unit 110 which reserves a ticket according to a ticket reservation request of the customer, a customer information database 120 which stores tickets issued by the ticket reservation processing unit 110 in correspondence with customer information corresponding thereto, a call termination service reception unit 130 which receives a mobile telephone call termination service request including the telephone number and the service provision time from the customer, and a call termination service processing unit 140 which transmits call termination service application information including the customer's mobile telephone number, service provision request time information and the representative telephone number of the airplane or the ship to the call termination service provision system 200 according to the call termination service request received by the call termination service reception unit 130, receives a call termination service application completion signal from the call termination service provision system 200, and notifies the customer that the call termination service application completion signal is received.

The ticket reservation processing unit 110 receives and processes the customer's request for the airplane or ship ticket reservation online or offline. The function of the ticket reservation processing unit 110 is provided by the airline company or the shipping company in advance and thus the detailed description thereof will be omitted.

The customer information database 120 is implemented by a mass storage device such as a hard disc and stores the tickets issued by the ticket reservation processing unit 110 in correspondence with customer information corresponding thereto.

The call termination service reception unit 130 requests the customer to input the customer's mobile telephone number and the service provision time and preferably the schedule of the airplane or the ship, when the customer applies for the mobile telephone call termination service at the time of online or offline ticket reservation. The call termination service reception unit 130 transmits the customer information and the input information to the call termination service processing unit 140 when the customer inputs the customer's mobile telephone number and the desired service provision time.

The call termination service processing unit 140 receives the service application information including the customer information, the customer's mobile telephone number and the service provision time from the call termination service reception unit 130, transmits the service request information including the customer information, the mobile telephone number, the service provision time and the representative telephone number of the airplane or the ship reserved by the customer to the call termination service provision system 200 of the mobile communication service provider of the corresponding customer's mobile telephone, and applies for the call termination service of the corresponding customer. The call termination service provision system 200 receives the call termination service request information, registers the call termination service of the corresponding mobile telephone, and outputs the call termination service application completion signal to the call termination service processing unit 140. The call termination service processing unit 140 notifies the customer of the service registration result.

The call termination service provision system 200 may be mounted in the mobile communication service provision system operated by the mobile communication service provider such as SK Telecom, KTF or LG Telecom or may be implemented by a separate system connected to the mobile communication service provision system. The call termination service provision system 200 is connected to the ticketing system 100 over a network including the Internet, receives the corresponding mobile telephone number, the representative telephone number of the airplane or the ship used by the customer and the service provision time information from the ticketing system 100 according to the call termination service application, registers the call termination service, and transmits the registration result to the ticketing system 100.

The airplane or the ship which flies or sails over open sea includes the representative telephone, that is, the satellite telephone, which can establish a call connection anywhere using a fixed telephone. In the present invention, the call termination service of the customer's mobile telephone is provided using the representative telephone.

The call termination service provision system 200 switches the mobile telephone to a call termination service state when a current time reaches the service provision time, that is, the flight time of the airplane or the sailing time of the ship, requested by the customer who applies for the call termination service. When a call connection to the mobile telephone which is in the call termination service state is requested, the call termination service provision system 200 transmits the call termination signal including the customer's mobile telephone number to the representative telephone number of the airplane or the ship, which is previously stored in correspondence with the telephone number. When the call connection is allowed by the internal switching system 300 of the airplane or the ship which receives the call termination signal, the call termination service provision system 200 establishes the call connection and provides a telephone conversation service.

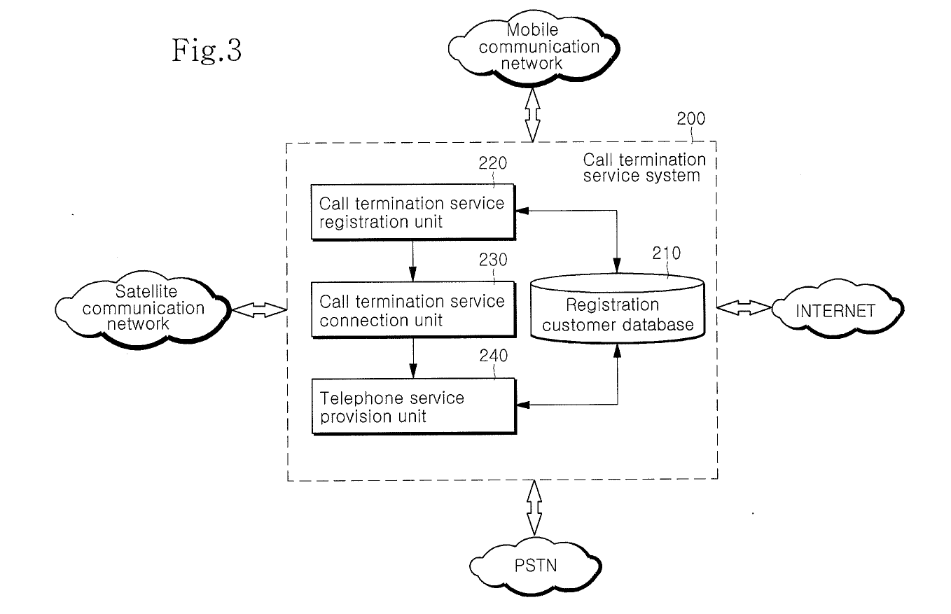

The description of the call termination service provision system 200 will be described in detail with reference to FIG. 3.

FIG. 3 is a schematic block diagram showing the call termination service providing system according to a preferred embodiment of the present invention. As shown, the call termination service provision system 200 according to the present invention includes a registration customer database 210 which stores the customer information, the mobile telephone number, the service provision time and the representative telephone number of the airplane or the ship according to the customers registered in the call termination service; a call termination service registration unit 220 which receives the call termination service application information from the call termination service processing unit, stores and registers the service provision request time information and the mobile telephone number of the customer and the representative telephone number of the airplane or the ship, and transmits the service registration completion signal to the call termination service processing unit; a call termination service connection unit 230 which determines whether a call connection request time is included in the service provision time when a call connection to the registered mobile telephone number is requested and transmits a call termination signal including the mobile telephone number to the representative telephone number of the corresponding airplane or the ship if it is determined that the call connection request time is included in the service provision time; and a telephone service provision unit 240 which provides a call connection service according to a connection command from the internal switching system 300.

The registration customer database 210 stores the customer information, the mobile telephone number, the service provision time and the representative telephone number of the airplane or the ship according to the customers registered by the call termination service registration unit 220.

The call termination service registration unit 220 receives the call termination service application information including the customer information, the mobile telephone number, the service provision time and the representative telephone number of the airplane or the ship purchased by the customer from the call termination service processing unit 140 of the ticketing system 100 connected thereto over the network including the Internet, stores the mobile telephone number and the representative telephone number of the airplane or the ship in correspondence with each other in the registration customer database 210, and transmits the service registration completion signal to the call termination service processing unit 140.

The call termination connection unit 230 checks the call termination service provision time of the mobile telephone when the call connection from a wired/wireless telephone to the mobile telephone number registered in the call termination service is requested, accesses the representative telephone number of the airplane or the ship corresponding to the mobile telephone number if it is determined that the call connection request time is included in the service provision time, and transmits the call termination signal including the mobile telephone number, which applies for the call termination service, to the representative telephone number of the corresponding airplane or the ship.

When a call connection allowance signal is received from the internal switching system 300 mounted in the airplane or the ship, the telephone service provision unit 240 establishes the call connection of the wired/wireless telephone which requests the call connection with the representative telephone number of the airplane or the ship and transmits/receives a voice signal to provide the call connection service.

The internal exchange service system includes the representative telephone mounted in the airplane or the ship, receives a call termination signal including a mobile telephone number from the call termination service provision server, searches for a customer corresponding to the mobile telephone number, and notifies the customer that a call is received. The customer goes to a predetermined position of the airplane or the ship where a telephone handset 320 is provided and conducts a telephone conversation through the telephone service provided by the telephone service provision unit 240.

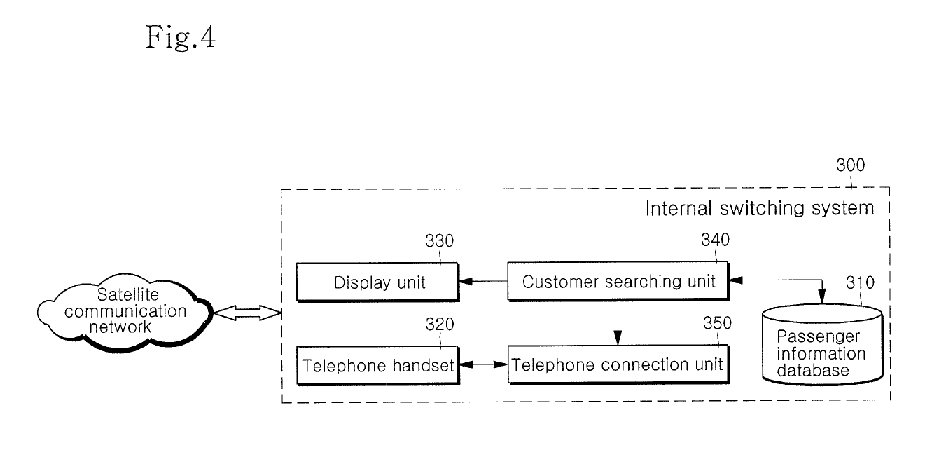

The description of the internal exchange service system will be described in detail with reference to FIG. 4.

FIG. 4 is a schematic block diagram showing an internal switching system according to a preferred embodiment of the present invention. As shown, the internal switching system according to the present invention includes a passenger information database 310 which stores the mobile telephone numbers and seat information of customers who apply for the call termination service, the telephone handset 320 which receives a call received by the representative telephone of the airplane or the ship, a display unit 330 which displays a position guide message of the telephone handset 320 and the customer information including the name and the telephone number of the customer, a customer searching unit 340 which receives a call termination signal including a telephone number from the call termination service provision system 200, searches for customer information corresponding thereto in the telephone database using the telephone number, and outputs the searched customer information to the display unit 330, and a telephone connection unit 350 which establishes the connection with the call termination service provision system 200 according to the call terminal allowance of the customer and provides the call termination service over the telephone handset 320.

The passenger information database 310 is, for example, a mass storage device such as a hard disc and stores personal information and seat information of the passengers and the mobile telephone numbers of the customers who apply for the call termination service. The stored information is accessed by the customer searching unit 340.

The telephone handset 320 is mounted at a predetermined position of the airplane or the ship, converts voice data received from the call termination service provision system 200 into audible sound to output the audible sound, converts input voice into voice data to transmit the voice data to the call termination service provision system 200, thereby allowing the customer to have a telephone conversation with a counterpart.

The display unit 330 is implemented by a liquid crystal display (LCD) device and displays the name and the telephone number of the customer searched by the customer searching unit 340 and the position guide message of the telephone handset 320 mounted at the predetermined position of the airplane or the ship, according to the call termination signal.

The customer searching unit 340 receives the call termination signal including the mobile telephone number from the call termination service provision system 200, accesses the customer information corresponding thereto from the passenger information database 310 using the mobile telephone number, and outputs the customer information to the display unit 330. When the call termination signal is received, the customer searching unit 340 extracts the mobile telephone number from the received call termination signal, searches the passenger information database 310 using the mobile telephone number as a keyword, and accesses the customer information. The customer searching unit 340 allows the display unit 330 to display the customer information accessed from the passenger information database 310 and the position guide message of the telephone handset 320.

The telephone connection unit 350 establishes the call connection with the telephone service provision unit 240 of the call termination service provision system according to the call terminal allowance command of the customer and provides the telephone service. The customer checks that the call is received by the customer's mobile telephone and goes to the place where the telephone handset 320 is mounted according to the guide. When the customer presses a key included in the telephone handset 320 to input the predetermined call connection allowance command, the telephone connection unit 350 transmits the input call connection allowance command to the telephone service provision unit 240 of the call termination service provision system 200 and establishes the call connection, thereby allowing the customer to have a telephone conversation.

The telephone connection unit 350 receives the voice data from the telephone service provision unit 240 of the call termination service provision system 200 and outputs the voice data to the telephone handset 320 such that the receiver of the telephone handset 320 converts the voice data into the audible sound and outputs the audible sound. When the telephone handset 320 converts the voice signal of the customer into the voice data and transmits the voice data to the telephone connection unit 350, the telephone connection unit 350 converts the voice data into a format suitable for transmission and transmits the converted data to the telephone service provision unit 240 of the call termination service server over the satellite communication.

In the system for providing the mobile telephone call termination service over open sea according to the present invention, particularly, in the airplane, an ear microphone 360 may be mounted in a customer's seat such that the customer receives the call termination service on his/her seat without going to the telephone handset 320 mounted at the predetermined position.

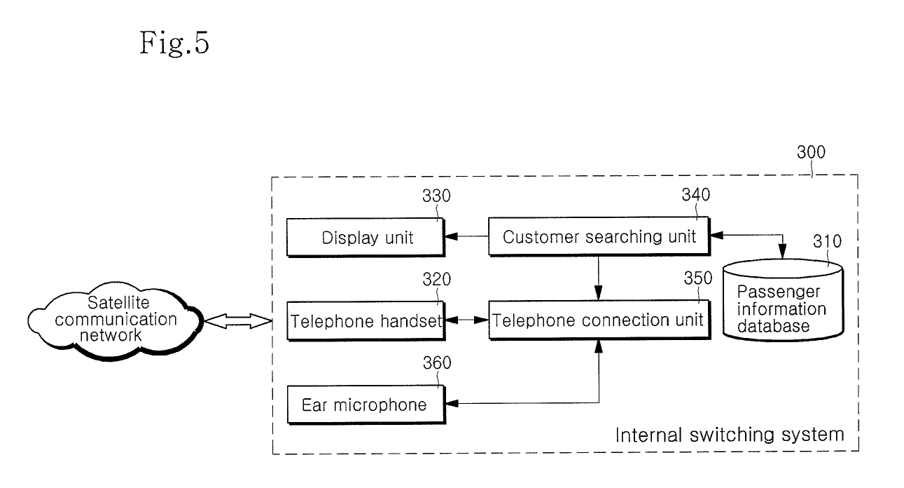

FIG. 5 is a schematic block diagram showing an internal switching system according to another embodiment of the present invention. As shown, the internal switching system 300 according to the present embodiment includes the ear microphone 360 which is mounted in the seat of the customer and provides the voice of a counterpart to the customer, who receives the telephone conversation service, and receives the voice of the customer. The customer searching unit 340 searches for a seat number of the customer using the passenger information database 310 and connects the call termination signal to the ear microphone 360 mounted in the searched seat of the customer.

The ear microphone 360 includes a small-sized speaker for outputting voice and a small-sized microphone for receiving voice and may be a hands-free microphone which is used in a mobile communication terminal. The ear microphone 360 is mounted at a predetermined position of the seat.

When the call termination signal including the mobile telephone number is received from the call termination service provision system 200, the customer searching unit 340 accesses the personal information and the seat number of the customer from the passenger information database 310 using the mobile telephone number, displays the personal information and the seat number of the customer and the received mobile telephone number, and notifies the customer sitting on the seat that the call is received, using an output device such as a buzzer which may be mounted in the seat.

The customer checks the name of the customer, the mobile telephone number and the seat number displayed on the display unit 330 or recognizes the call termination signal output from the output device mounted in his/her seat to receive the call termination service through the ear microphone 360.

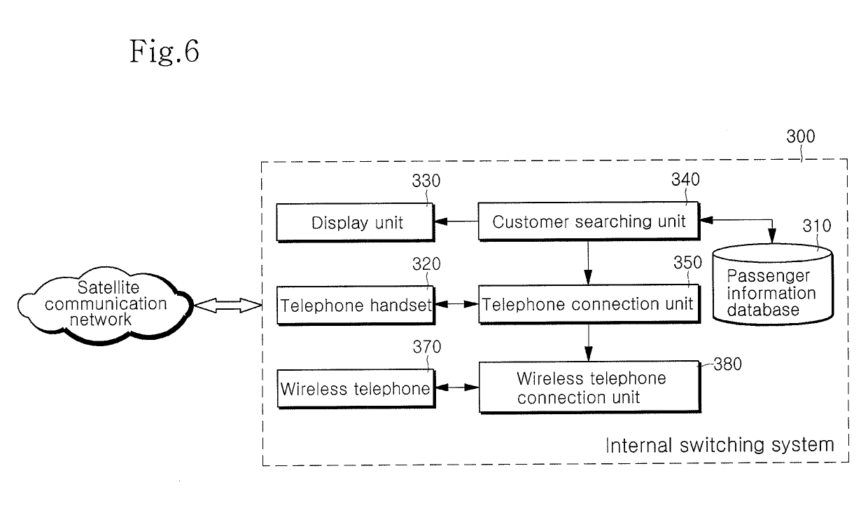

FIG. 6 is a schematic block diagram showing an internal switching system according to another embodiment of the present invention. As shown, the internal switching system 300 according to the present embodiment further includes a wireless telephone 370 having identification information and mounted at a predetermined position of a customer's seat. The passenger information database 310 stores the identification information of the wireless telephone 370 mounted in the seat. The internal switching system 300 further includes a wireless telephone connection unit 380 which transmits the call termination signal to the wireless telephone 370 mounted in the customer seat searched by the customer searching unit 340.

The wireless telephone 370 has the same form as the general wireless telephone 370 used in a home or a mobile communication terminal and has the identification information. An output device which receives the call termination signal from the wireless telephone connection unit 380 and notifies the customer that the call termination signal is received, such as a buzzer or an alarm, is further included.

When the call termination signal including the mobile telephone number is received from the call termination service provision system 200, the customer searching unit 340 accesses the personal information and the seat number of the customer and the identification information of the wireless telephone 370 corresponding thereto using the mobile telephone number and outputs them to the wireless telephone connection unit 380. The wireless telephone connection unit 380 transmits the call termination signal to the wireless telephone 370 corresponding to the identification information received from the customer searching unit 340 using a wireless communication protocol such as Bluetooth, RF, or Zigbee and establishes the connection of the telephone connection unit 350 and the wireless telephone 370 when the customer inputs the call connection allowance command, such that the customer receives the call termination service.

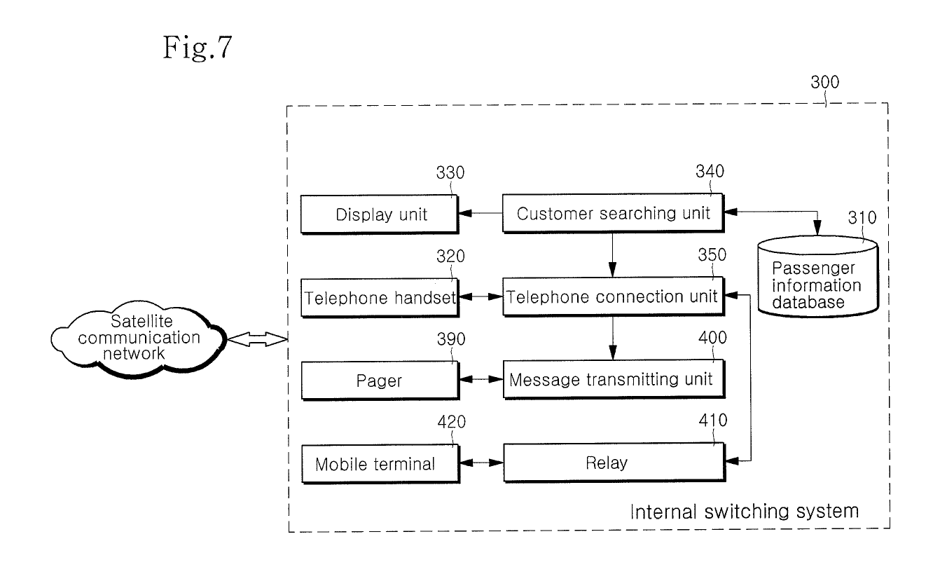

FIG. 7 is a schematic block diagram showing an internal switching system according to another embodiment of the present invention. As shown, the internal switching system according to the present embodiment further includes a pager 390 which has identification information and is provided to a customer who applies for the call termination service. The passenger information database 310 stores the identification information of the pager 390. The internal switching system 300 further includes a message transmitting unit 400 which transmits a guide message that the call termination signal is received to the pager 390 of the customer searched by the customer searching unit 340.

Since the size of the ship is large unlike the airplane, passengers can freely travel in the ship. Accordingly, in order to efficiently notify a customer who freely travels that a call is received by his/her mobile telephone, the pager 390 is used. The pager 390 is a small-sized receiver for receiving a radio frequency signal and notifying a possessor of a call with sound, vibration or light and is also called a “beeper”. The pager 390 is a unidirectional device which cannot transmit a message and can receive a variety of alphanumeric message contents. This device has a simple structure, light weight, low cost and convenience in use.

When the call termination signal including the mobile telephone number is received from the call termination service provision system 200, the customer searching unit 340 accesses the personal information and the seat number of the customer and the identification information of the pager 390 corresponding thereto from the passenger information database 310 using the mobile telephone number and outputs them to the message transmitting unit 400.

The message transmitting unit 400 generates a message that a call is received and a place where the representative telephone of the ship is mounted, using the customer information and the identification information of the pager received from the customer searching unit 340, and outputs them to the pager provided to the customer 390. The customer confirms that the call is received through the pager 390 and goes to the place where the telephone handset 320 is mounted so as to have a telephone conversation.

The internal switching system 300 according to the present embodiment further includes at least one relay 410 which is mounted at a predetermined position of the ship with a predetermined gap interposed therebetween and transmits a call termination signal in a predetermined range, and a mobile terminal 420 which is possessed by the customer, has identification information, receives the call termination signal from the relay 410, notifies the customer that the call termination signal is received, and provides the telephone service according to the call termination allowance command of the customer.

Since the size of the ship is large unlike the airplane, passengers can freely travel in the ship. Accordingly, in order to efficiently notify a customer who freely travels that a call is received by his/her mobile telephone, the relay 410 which transmits a radio frequency signal in the predetermined range and the mobile terminal 420 which transmits/receives data in the predetermined range are used.

The mobile terminal 420 may include, for example, a mobile communication terminal having only a call termination function. The mobile terminal 420 establishes the connection with the relay 410 in a predetermined period, receives the call termination signal including its identification signal from the relay 410, notifies the customer that a call is received, using a bell or vibration, and provides the call connection service through the relay 410 when the customer inputs a call connection command.

When the call termination signal including the mobile telephone number is received from the call termination service provision system 200, the customer searching unit 340 accesses the personal information of the customer and the identification information of the mobile terminal 420 corresponding thereto from the passenger information database 310 using the mobile telephone number, and outputs them to the wireless telephone connection unit 380. The wireless telephone connection unit 380 transmits the call termination signal including the identification information of the mobile telephone received from the customer searching unit 340 to the at least one relay mounted in the ship, and the relay 410 transmits the call termination signal in the predetermined range. When the mobile terminal 420 having the identification information receives the call termination signal and notifies the customer that the call termination signal is received using the bell or vibration, the customer inputs the call termination allowance command using a predetermined button mounted in the mobile terminal 420, and the relay 410 establishes the connection between the mobile terminal 420 and the telephone connection unit 350, such that the customer receives the call termination service.

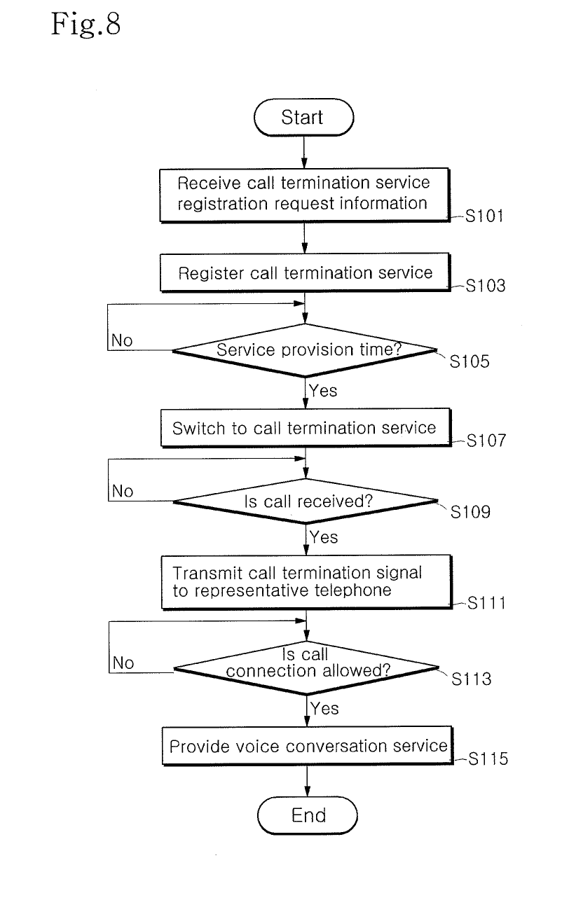

FIG. 8 is a flowchart illustrating a method for providing a mobile telephone call termination service over open sea using the mobile telephone call termination service provision system according to the preferred embodiment of the present invention. As shown, the method for providing the mobile telephone call termination service over open sea according to the present invention includes storing and registering the mobile telephone number of a customer or the representative telephone number of an airplane or a ship in correspondence with each other according to the request for the mobile telephone call termination service including the mobile telephone number and the service provision time when the customer purchases a ticket of the airplane or the ship; comparing a call connection request time with a service provision request time when a call connection to the registered mobile telephone number is requested and transmitting a call termination signal including the mobile telephone number to the representative telephone of the airplane or the ship corresponding thereto when the call connection request time is included in the service provision request time; and receiving a call connection command from the representative telephone, establishing a call connection to the representative telephone of the airplane or the ship, and providing a telephone service.

The customer purchases a ticket at a ticket window of an airport or a harbor or through an online ticket reservation service using the Internet so as to use an airplane or a ship. At this time, a customer who wants a call termination service for receiving a call by his/her mobile telephone over open sea makes a request for the call termination service at the time of ticketing. The ticketing system 100 operated by the airline company or the shipping company receives the request for the call termination service and makes a request for the mobile telephone number of the customer and desired service provision time information. When the customer provides the information, the ticketing system transmits call termination service registration request information including the mobile telephone number, the time information, and the representative telephone number of the airplane or the ship to the call termination service provision system 200 operated by a mobile communication service provider.

The call termination service provision system 200 receives call termination service registration request information (S101), and stores and registers the mobile telephone number of the customer, the representative telephone number of the airplane or the ship and the service provision time information (S103).

The call termination service provision system 200 switches the mobile telephone to a call termination service state (S107) when a current time reaches a time requested by the customer who applies for the call termination service (S105). When a call is received by the mobile telephone of the customer who applies for the call termination service, it is checked whether the mobile telephone of the customer is in the call termination service state using the mobile telephone number (S109). At this time, the call termination service provision time is the operation time of the airplane or the ship. The call termination service provision service system 200 compares the call connection request time with the service provision request time and transmits the call termination signal to the representative telephone, that is, the internal switching system 300, of the airplane or the ship registered in correspondence with the mobile telephone number if the call connection request time is included in the call termination service provision time (S111).

The internal switching system 300 mounted in the airplane or the ship searches for the customer using the mobile telephone number included in the received call termination signal, notifies the customer that the call is received, and transmits the call connection allowance command of the customer to the call termination service provision system 200.

The call termination service provision system 200 receives the call connection allowance command (S113), and establishes the connection to the representative telephone of the airplane or the ship to provide a voice conversation service (S115).

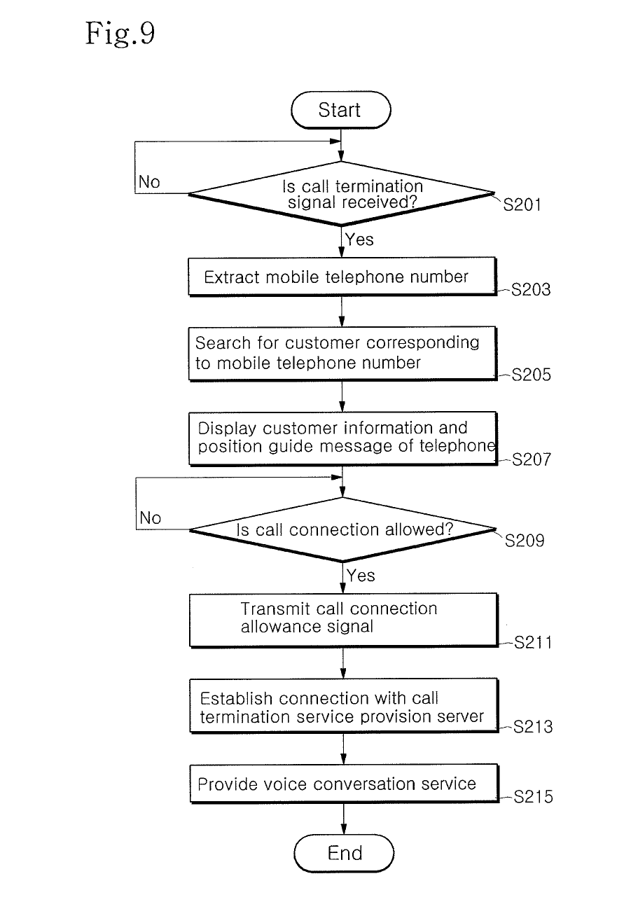

FIG. 9 is a flowchart illustrating a method for providing a mobile telephone call termination service over open sea using the internal switching system according to the preferred embodiment of the present invention. As shown, the method for providing the mobile telephone call termination service over open sea according to the present invention includes storing and registering the mobile telephone number of a customer or the representative telephone number of an airplane or a ship in correspondence with each other according to the request for the mobile telephone call termination service including the mobile telephone number and the service provision time when the customer purchases a ticket of the airplane or the ship, comparing a call connection request time with a service provision request time when a call connection to the registered mobile telephone number is requested, transmitting a call termination signal including the mobile telephone number to the representative telephone of the airplane or the ship corresponding thereto when the call connection request time is included in the service provision request time, receiving a call connection command from the representative telephone, establishing a call connection to the representative telephone of the airplane or the ship, and receiving the call termination signal from the call termination service provision system 200 for providing a telephone service; extracting the mobile telephone number from the received call termination signal, searching for the customer corresponding thereto, displaying the customer information including the name and the telephone of the customer and a position guide message of the telephone handset 320 on the display unit 330, and notifying the customer that the call is received; and establishing the connection with the call termination service provision system 200 according to the call connection command of the customer received through the telephone handset 320 and providing the telephone service.

The customer purchases a ticket at a ticket window of an airport or a harbor or through an online ticket reservation service using the Internet so as to use an airplane or a ship. At this time, a customer who wants a call termination service for receiving a call by his/her mobile telephone over open sea makes a request for the call termination service at the time of ticketing. The ticketing system 100 operated by the airline company or the shipping company receives the request for the call termination service and makes a request for the mobile telephone number of the customer and desired service provision time information. When the customer provides the information, the ticketing system transmits call termination service registration request information including the mobile telephone number, the time information, and the representative telephone number of the airplane or the ship to the call termination service provision system 200 operated by a mobile communication service provider.

The call termination service provision system 200 receives call termination service registration request information and stores and registers the mobile telephone number of the customer, the representative telephone number of the airplane or the ship, and the service provision time information.

The call termination service provision system 200 switches the mobile telephone to the call termination service state when a current time reaches a time requested by the customer who applies for the call termination service. When a call is received by the mobile telephone of the customer who applies for the call termination service, it is checked whether the mobile telephone of the customer is in the call termination service state using the mobile telephone number. At this time, the call termination service provision time is the operation time of the airplane or the ship. The call termination service provision service system 200 compares the call connection request time with the service provision request time and transmits the call termination signal to the representative telephone, that is, the internal switching system 300, of the airplane or the ship registered in correspondence with the mobile telephone number if the call connection request time is included in the call termination service provision time.

When the call termination signal is received, the customer searching unit 340 of the internal switching system 300 mounted in the airplane or the ship extracts the mobile telephone number of the received call termination signal (S203), searches the passenger information database 310 using the mobile telephone number as a keyword, and accesses customer information (S205). The customer searching unit 340 allows the display unit 330 to display the customer information accessed from the passenger information database 310 and the position guide message of the telephone handset 320 (S207).

The customer confirms the name and the mobile telephone number of the customer and the position guide message of the telephone handset 320 displayed on the display unit 330, goes to the place where the telephone handset 320 is mounted according to the guide information when the call is received by his/her mobile telephone, and inputs the call connection command by pressing the predetermined button mounted in the telephone handset 320 (S209). When the customer inputs the call connection command, the telephone connection unit 350 of the internal switching system 300 transmits the call connection allowance signal to the call termination service provision system 200 according to the call connection allowance command of the customer (S211), receives voice data from the telephone service provision unit 240, and outputs the voice data to the telephone handset 320, and the receiver of the telephone handset 320 converts the voice data into audible sound and outputs the audible sound. When the telephone handset 320 converts the voice signal of the customer into voice data and transmits the converted voice data to the telephone connection unit 350, the telephone connection unit 350 converts the voice data into a format suitable for transmission and transmits the converted signal to the telephone service provision unit 240 of the call termination service server over satellite communication (S213 and S215).

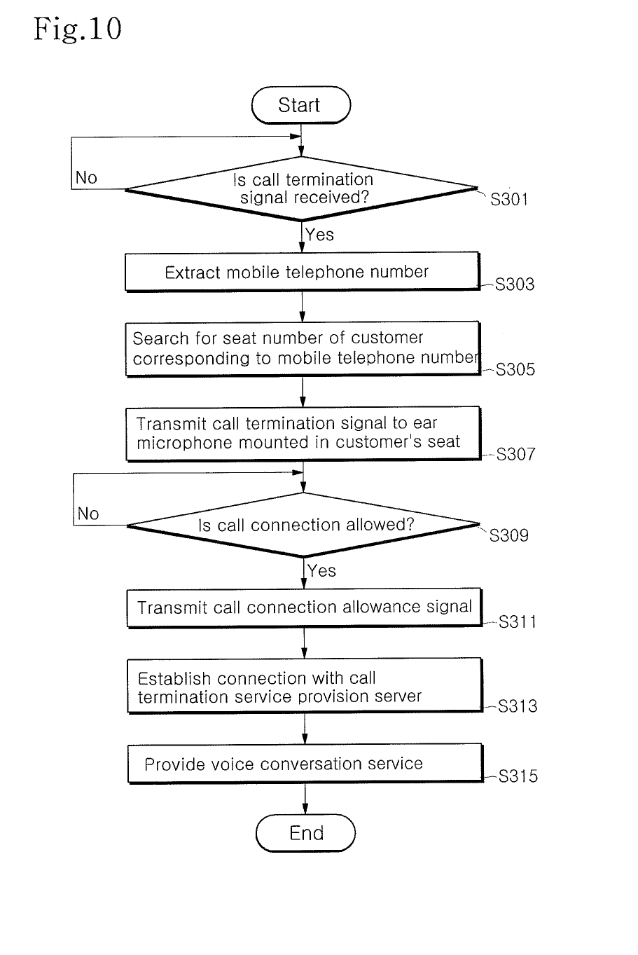

FIG. 10 is a flowchart illustrating a method for providing a mobile telephone call termination service over open sea using the internal switching system according to another embodiment of the present invention. As shown, the internal switching system according to the present invention may include the ear microphone 360 for receiving the call termination service on his/her seat through input/output of the voice data. The method for providing the mobile telephone call termination service includes extracting the mobile telephone number from the received call termination signal, and searching for information about the seat of the customer corresponding thereto, and transmitting the call termination signal to the ear microphone 360 mounted in the seat of the searched customer.

When the call termination signal including the mobile telephone number is received from the call termination service provision system 200 (S301), the customer searching unit 340 of the internal switching system 300 extracts the mobile telephone number (S303), accesses the personal information and the seat number of the customer from the passenger information database 310 using the mobile telephone number (S305), displays the personal information and the seat number of the customer together with the mobile telephone number to notify the customer that the call is received using the output device mounted in the seat, such as a buzzer (S307).

When the customer inputs the call connection allowance command (S309), the telephone connection unit 350 of the internal switching system 300 transmits the call connection allowance command to the call termination service provision system 200 according to the call connection allowance command of the customer (S311), receives voice data from the telephone service provision unit 240, outputs the voice data to the ear microphone 360. When the ear microphone 360 converts the voice signal of the customer into voice data and transmits the voice data to the telephone connection unit 350, the telephone connection unit 350 converts the voice data into a format suitable for transmission and transmits the converted signal to the telephone service provision unit 240 of the call termination service server (S313 and S315).

The customer confirms the name, the mobile telephone number and the seat number of the customer displayed on the display unit 330 or recognizes the call termination signal output from the output device mounted in his/her seat so as to receive the call termination service through the ear microphone 360.

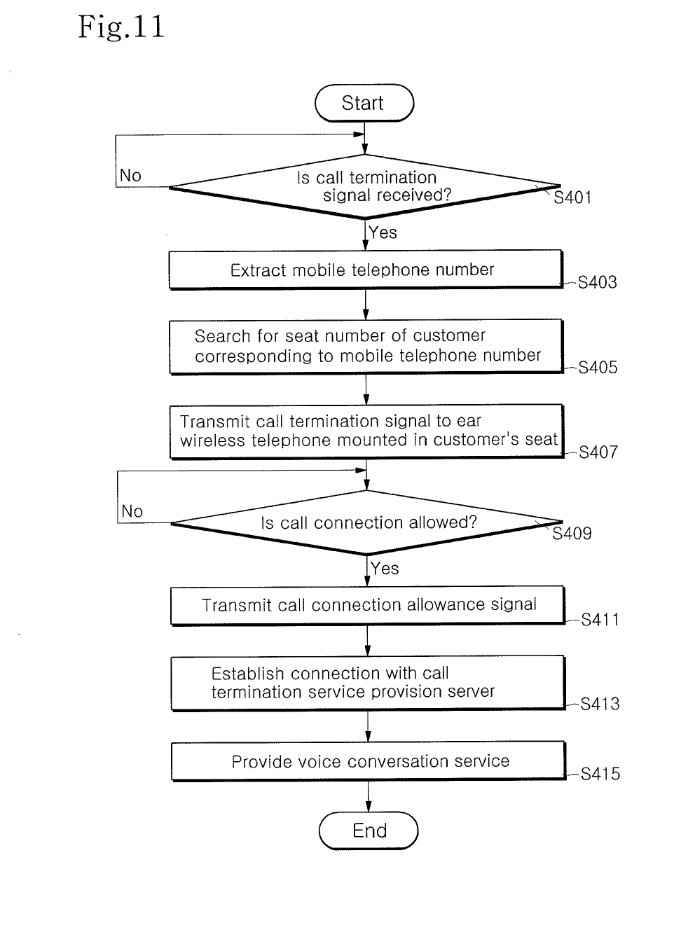

FIG. 11 is a flowchart illustrating a method for providing a mobile telephone call termination service over open sea using the internal switching system according to the another embodiment of the present invention. As shown, the internal switching system 300 according to the present embodiment further include the wireless telephone 370 which has the identification information and is mounted at the predetermined position of the customer's seat so as to provide the customer to the telephone conversation service. The method for providing the mobile telephone call termination service over open sea according to the present invention further includes extracting the mobile telephone number from the received call termination signal, searching for the seat information of the customer corresponding thereto, and transmitting the call termination signal to the wireless telephone 370 mounted in the seat of the searched customer.

The wireless telephone 370 has the same form as the general wireless telephone 370 used in a home or a mobile communication terminal and has identification information. An output device which receives the call termination signal from the wireless telephone connection unit 380 and notifies the customer that the call termination signal is received, such as a buzzer or an alarm, is further included.

When the call termination signal including the mobile telephone number is received from the call termination service provision system 200 (S401), the customer searching unit 340 extracts the mobile telephone number (S403), and accesses the personal information and the seat number of the customer and the identification information of the wireless telephone 370 corresponding thereto from the passenger information database 310 and outputs them to the wireless telephone connection unit 380 (S405). The wireless telephone connection unit 380 transmits the call termination signal to the wireless telephone 370 corresponding to the identification information received from the customer searching unit 340 (S407). When the customer inputs the call connection allowance command (S409), the telephone connection unit 350 of the internal switching system 300 transmits the call connection allowance signal to the call termination service provision system 200 according to the call connection allowance command of the customer (S411) and establishes the connection between the telephone connection unit 350 the wireless telephone 370, such that the customer receives the call termination service (S413 and S415).

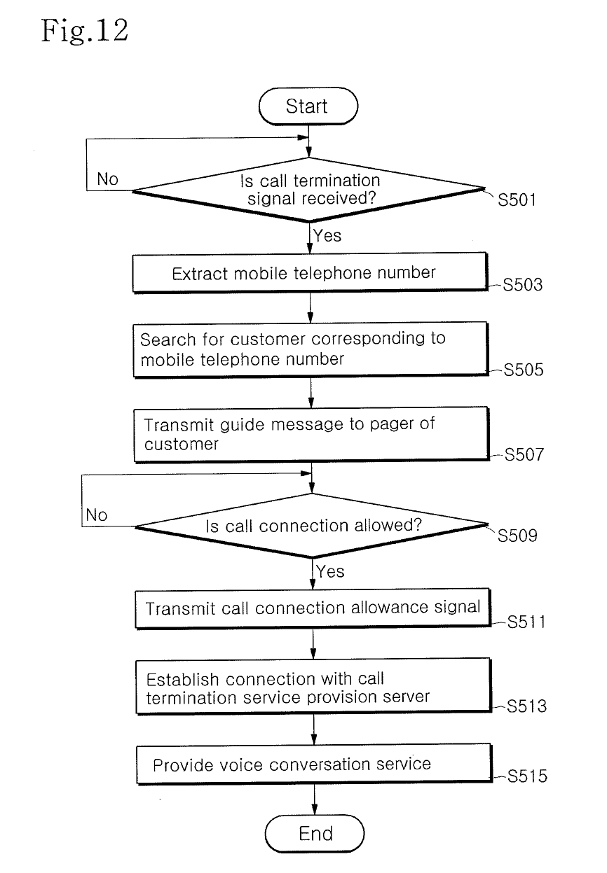

FIG. 12 is a flowchart illustrating a method for providing a mobile telephone call termination service over open sea using the internal switching system according to the another embodiment of the present invention. As shown, the internal switching system 300 according to the present embodiment further includes the pager 390 which has identification information and is provided to the customer who applies for the call termination service. The method for providing the mobile telephone call termination service over open sea according to the present invention further includes extracting the mobile telephone number from the received call termination signal, searching for the identification information of the pager 390 of the customer corresponding thereto, and transmitting a guide message according to the received call to the pager 390 of the customer.

When the call termination signal including the mobile telephone number is received from the call termination service provision system 200 (S501), the customer searching unit 340 extracts the mobile telephone number (S503), and accesses the personal information and the seat number of the customer and the identification information of the pager 390 corresponding thereto from the passenger information database 310 and outputs them to the message transmitting unit 400 (S505).

The message transmitting unit 400 generates a message that the call is received through the pager 390 provided to the customer and the positional information of the representative telephone of the ship using the customer information and the identification information of the pager 390 received from the customer searching unit 340 and outputs them to the pager (S507). The customer confirms the call is received through the pager 390, goes to the place where the telephone handset 320 is mounted, and inputs the call connection command by pressing the predetermined button mounted in the telephone handset 320 (S509). When the customer input the call connection command, the telephone connection unit 350 of the internal switching system 300 transmits the call connection allowance signal to the call termination service provision system 200 according to the call termination call connection allowance command of the customer (S511), receives the voice data from the telephone service provision unit 240, and outputs the voice data to the telephone handset 320. The receiver of the telephone handset 320 converts the voice data into audible sound and outputs the audible sound. When the telephone handset 320 converts the voice signal of the customer into voice data and transmits the voice data to the telephone connection unit 350, the telephone connection unit 350 converts the voice data into a format suitable for transmission and transmits the converted signal to the telephone service provision unit 240 of the call termination service server over satellite communication (S513 and S515).

According to a method and system for providing a mobile telephone call termination service of the present invention, it is possible to provide a call termination service to a customer over open sea.

In addition, since an ear microphone or a dedicated wireless telephone mounted in a customer's seat is further included, it is possible to easily provide the call termination service to the customer through an internal switching system mounted in an airplane or a ship.

In addition, since a pager is provided to the customer, it is possible to provide the call termination service to the customer through the pager when a call is received in a space where the customer freely travels, such as a large ship.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for providing a mobile telephone call termination service over open sea, the system comprising:
a ticketing system which issues a ticket of an airplane or a ship according to a customer's request, and applies to a mobile communication service provider of a customer's mobile telephone for a call termination service including a mobile telephone number of a customer, a service time and a representative telephone number of the airplane or the ship according to a customer's request for the mobile telephone call termination service including the mobile telephone number and a service provision time;
a call termination service provision system which stores the mobile telephone number of the customer and the representative telephone number of the airplane or the ship in correspondence with each other according to call termination service application received from the ticketing system, transmits a call termination signal including the mobile telephone number to the representative telephone of the airplane or the ship corresponding to the telephone when a call connection to the mobile telephone number is requested, and establishes a call connection according to a connection command of the customer; and
an internal switching system which is mounted in the airplane or the ship, receives the call termination signal from the call termination service provision server, searches for the customer corresponding to the telephone number, notifies the customer that the call termination signal is received, and transmits/receives voice data to/from the call termination service provision system according to a call connection request of the customer.

2. The system according to claim 1, wherein the ticketing system includes:
a ticket reservation processing unit which processes reservation of the ticket according to a ticket reservation request of the customer;
a customer information database which stores customer information corresponding to the ticket issued by the ticket reservation processing unit;
a call termination service reception unit which receives the request for the mobile telephone call termination service including the telephone number and the service provision time from the customer;
a call termination service processing unit which transmits call termination service application information including the mobile telephone number of the customer, service provision request time information and the representative telephone number of the airplane or the ship to the call termination service provision system according to the call termination service request received by the call termination service reception unit, receives a call termination service application completion signal from the call termination service provision system, and notifies the customer that the call termination service application completion signal is received.

3. The system according to claim 1, wherein the call termination service provision system includes:
a registration customer database which stores customer information, the mobile telephone number, the service provision time and the representative number of the airplane or the ship according to customers registered in a call termination service;
a call termination service registration unit which receives the call termination service application information from the call termination service processing unit, stores and registers the mobile telephone number of the customer, the service provision request time information and the representative telephone number of the airplane or the ship in correspondence with each other, and transmits the service application completion signal to the call termination service processing unit;
a call termination service connection unit which compares a call connection request time with a service provision request time when a call connection to the registered mobile telephone number is requested, and transmits a call termination signal including the mobile telephone number to the representative telephone of the airplane or the ship corresponding thereto when the call connection request time is included in the service provision request time; and
a telephone service provision unit which provides a call connection service according to the connection command from the internal switching system.

4. The system according to claim 1, wherein the internal switching system includes:
a passenger information database which stores the mobile telephone number and seat information of the customer who applies for the call termination service;
a telephone handset which receives a call received by the representative telephone of the airplane or the ship;
a display unit which displays customer information including the name and the telephone number of the customer and a position guide message of the telephone handset;
a customer searching unit which receives the call termination signal including the telephone number from the call termination service provision system, searches for customer information corresponding thereto in the database using the telephone number, and outputs the searched customer information to the display unit; and
a telephone connection unit which establishes a connection with the call termination service provision system according to a call termination allowance command of the customer and provides the call termination service through the telephone handset.

5. The system according to claim 4, wherein the internal switching system further includes an ear microphone mounted in a seat of the customer.

6. The system according to claim 5, wherein the customer searching unit connects the call termination service to the ear microphone mounted in the seat of the customer searched from the passenger information database.

7. The system according to claim 4, wherein the internal switching system further includes a wireless telephone which has identification information and is mounted at a predetermined position of a seat of the customer.

8. The system according to claim 7, wherein the internal switching system further includes a wireless telephone connection unit which wirelessly transmits the call termination signal to the wireless telephone mounted in the seat of the customer searched by the customer searching unit.

9. The system according to claim 4, wherein the internal switching system further includes a pager which has identification information and is provided to the customer who applies for the call termination service.

10. The system according to claim 9, wherein the internal switching system further includes a message transmitting unit which transmits a guide message according to call termination to the pager of the customer searched by the customer searching unit.

11. The system according to claim 4, wherein the internal switching system further includes at least one relay which is mounted at a predetermined position of the ship with a gap interposed therebetween and transmits the call termination signal in a predetermined range.

12. The system according to claim 11, wherein the internal switching system further includes a mobile terminal which is possessed by the customer, has identification information, receives the call termination signal from the relay, notifies the customer that the call termination signal is received, and provides a telephone service according to a call termination allowance command of the customer.

13. A method for providing a mobile telephone call termination service over open sea, the method comprising:
storing and registering a mobile telephone number of a customer or a representative telephone number of an airplane or a ship in correspondence with each other according to a request for the mobile telephone call termination service including the mobile telephone number and the service provision time when the customer purchases a ticket of the airplane or the ship;
comparing a call connection request time with a service provision request time when a call connection to the registered mobile telephone number is requested and transmitting a call termination signal including the mobile telephone number to the representative telephone of the airplane or the ship corresponding thereto when the call connection request time is included in the service provision request time; and
receiving a call connection command from the representative telephone, establishing a call connection to the representative telephone of the airplane or the ship, and providing a telephone service.

14. A method for providing a mobile telephone call termination service over open sea, the method comprising:
storing and registering a mobile telephone number of a customer or a representative telephone number of an airplane or a ship in correspondence with each other according to a request for the mobile telephone call termination service including the mobile telephone number and the service provision time when the customer purchases a ticket of the airplane or the ship, comparing a call connection request time with a service provision request time when a call connection to the registered mobile telephone number is requested, transmitting a call termination signal including the mobile telephone number to the representative telephone of the airplane or the ship corresponding thereto when the call connection request time is included in the service provision request time, receiving a call connection command from the representative telephone, establishing a call connection to the representative telephone of the airplane or the ship, and receiving the call termination signal from a call termination service provision system for providing a telephone service;
extracting the mobile telephone number from the received call termination signal, searching for the customer corresponding thereto, displaying the customer information including the name and the telephone of the customer and a position guide message of a telephone handset on a display unit, and notifying the customer that the call is received; and
establishing a connection with the call termination service provision system according to the call connection command of the customer received through the telephone handset and providing the telephone service.

15. The method according to claim 14, further comprising extracting the mobile telephone number from the received call termination signal, searching for seat information of the customer corresponding thereto, and connecting the call termination signal to an ear microphone mounted in a seat of the searched customer.

16. The method according to claim 14, further comprising extracting the mobile telephone number from the received call termination signal, searching for seat information of the customer corresponding thereto, and wirelessly transmitting the call termination signal to a wireless telephone mounted in a seat of the searched customer.

17. The method according to claim 14, further comprising extracting the mobile telephone number from the received call termination signal, searching for the identification information of the pager of the customer corresponding thereto, and transmitting a guide message according to the received call to the pager of the customer.

18. The method according to claim 14, further comprising extracting the mobile telephone number from the received call termination signal, searching for identification information of a CT phone of the customer corresponding thereto, and wirelessly transmitting the call termination signal to the CT phone of the searched customer.
